(19) United States
(12) Patent Application Publication
(10) Pub. No.: US 2006/0255154 A1
(43) Pub. Date: Nov. 16, 2006

(54) Transaction card carrier assemblies

(75) Inventors: Keith Newbrough, Parker, CO (US); Chris McGee, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/155,323

(22) Filed: Jun. 17, 2005

Related U.S. Application Data
(60) Provisional application No. 60/680,408, filed on May 11, 2005.

(51) Int. Cl. G06K 7/00; G06K 5/00

(52) U.S. Cl. 235/486; 235/380

(57) ABSTRACT

The transaction card carrier assemblies of the invention generally include a carrier module releasably secured to a transaction card. In one aspect, the carrier module may be configured so as to allow for display of (e.g., visual access to) substantially all visual information located on the front and back of the transaction card while the transaction card is secured to the carrier module. In certain embodiments, secure (e.g., confidential or security oriented) information, such as personal identification number (PIN) information, may be obstructed from view until after purchase or delivery for security reasons, as is known in the art.

### CROSS-REFERENCES TO RELATED APPLICATIONS

This application claims the benefit of the filing date of U.S. Provisional Application No. 60/680,408, filed on May 11, 2005, the contents of which are incorporated herein by reference.

### BACKGROUND OF THE INVENTION

The present invention is related to transaction cards, and more specifically, to transaction card carrier assemblies, and methods of making.

Transaction cards, such as credit cards, debit cards, membership cards, stored value cards, and the like, are widely used. Such cards may include a variety of different indicia to identify the card and other features, such as the card issuer, the customer, terms and conditions of use, or the like, depending in part on the type of card. The information may be printed on the card using alphanumeric characters, graphics, or the like, or may be embossed into the card. Alternatively, some or all the information may be encoded on the card, such as in a magnetic strip attached to the card.

Some transaction cards are coupled to a carrier having additional information printed thereon. For example, stored value cards sold in retail locations may have a carrier containing terms and conditions of use, promotional information, and other inducements to buy the card. The cards may be attached to the carrier, such as with an adhesive strip. Many transaction cards are coupled to their carriers in a way that makes reading or scanning those cards difficult using standard point-of-sale devices. Further, visibility of the printed materials on the card and the carrier may be limited. For example, the information (e.g., encoded data and/or printed text) may be on the side of the card affixed to the card carrier. Further, the card that has information exposed runs the risk of damage (e.g., damage to a magnetic strip or printed data). Inadvertent separation of the card from the carrier also may present problems. As such, improvements are desired.

### BRIEF SUMMARY OF THE INVENTION

The present invention relates to transaction card carrier assemblies and methods. The transaction card carrier assemblies generally comprise a carrier module and a transaction card releasably secured thereto. The carrier module may be coupled to the transaction card, or alternatively may be integrally formed with the transaction card. In one aspect, the carrier module is configured so as to allow for access (e.g., visual and/or physical access) to transaction card identifier information (e.g., a magnetic strip, embossed account information, printed personal identification number (PIN) information, etc.) In another aspect, the carrier module is configured so as to allow for display of substantially all visual information located on the front surface and/or back surface of the affixed transaction card (e.g., configured so as to minimize obstruction of visual access to both front and back of the transactional card while secured to the carrier module). These and other aspects of the invention will be described in further detail below.

### BRIEF DESCRIPTION OF THE DRAWINGS

FIG. 1A shows a partial front view and 1B shows a rear view of an exemplary embodiment of the invention.

FIG. 2A shows a partial front view and 2B shows a rear view of another exemplary embodiment of the invention.

FIG. 3 illustrates yet another exemplary embodiment of the invention.

FIG. 4A shows a front view and 4B shows a rear view of another exemplary embodiment of the invention.

### DETAILED DESCRIPTION OF THE INVENTION

The transaction card carrier assemblies of the invention generally comprise a carrier module releasably secured to a transaction card, wherein the carrier module is configured so as to allow for display of (e.g., visual access to) substantially all visual information located on the front surface and/or back surface of the transaction card while the transaction card is secured to the carrier module. In certain embodiments, secure (e.g., confidential or security oriented) information, such as personal identification number (PIN) information, may be obstructed from view until after purchase or delivery for security reasons, as is known in the art.

Transaction cards of the present invention may be a wide variety of cards sent to customers or available for purchase by the consuming public. Cards could be used for functions similar to or the same as those described in pending U.S. patent application Ser. No. 9/971,303, filed Oct. 3, 2001, entitled Stored Value Cards and Methods for Their Issuance; U.S. patent application Ser. No. 10/421,604, filed Apr. 22, 2003, entitled Multi-Purse Card Systems and Methods; and U.S. patent application Ser. No. 10/744,888, filed Dec. 23, 2003, entitled Stored Value Lottery Card and Methods, each of which are assigned to the assignee of the present invention, with the complete disclosures of each being incorporated herein by reference for all purposes. In some embodiments, cards of the present invention include ValueLink® gift cards manufactured and/or distributed by First Data Corporation of Englewood, Colo.

Generally, the transaction cards may have data and/or information displayed on one or both sides of the card, i.e., the front and/or back of the card. Such information may include transaction card identifier information (e.g., a magnetic strip, embossed account information, printed personal identification number (PIN) information, etc.), terms and conditions of use, instructional materials, promotional materials, etc. In the context of the present invention, it is often desirable to ensure that all data and information displayed on a transaction card is visible, either directly or indirectly, while the card is secured to the carrier module (i.e., prior to removing the card from the carrier). In this way, potential purchasers may have complete visual access to all information displayed on the transaction card, including, for example, terms and conditions of use, instructional materials, etc.

Except as otherwise noted, the various components of the carrier modules may be constructed from any suitable material known in the art for such purposes. For instance, the components of the carrier modules may be constructed from cardboard, laminated cardboard, polyester, polyethylene, PVC, etc. Further, unless otherwise noted, the carrier module may be sized as desired for display purposes, as recognized by those skilled in the art. The carrier module may also incorporate various perforations, folds, or “doors” for incorporation of instructional information, promotional materials, etc. (see, e.g., U.S. Pat. No. 5,918,909, the contents of which are herein incorporated by reference in its entirety).

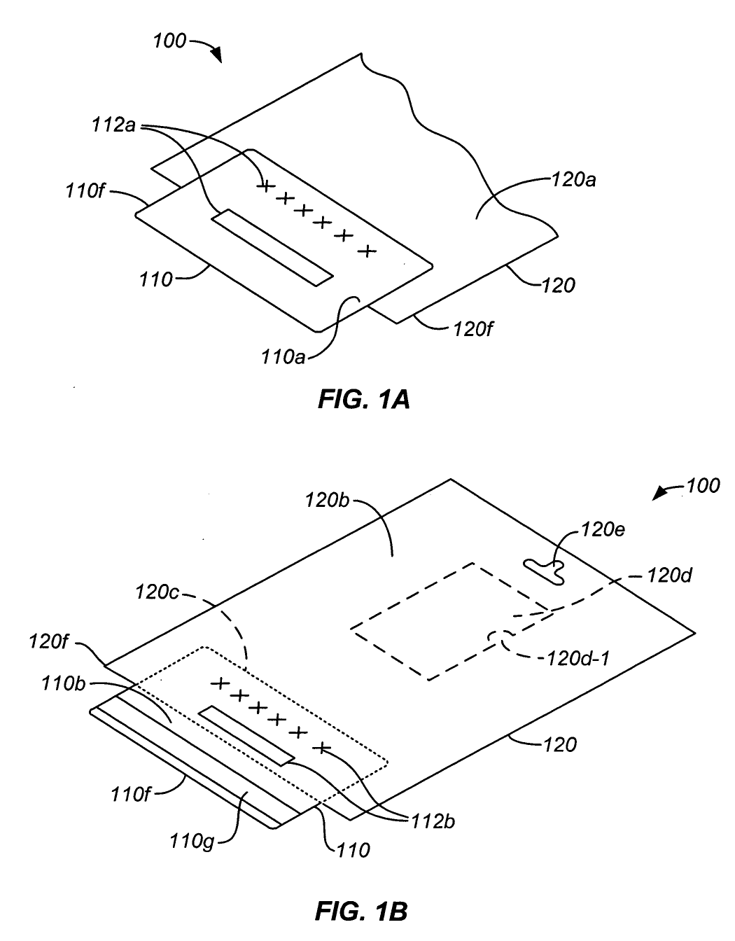

Now, with reference to FIGS. 1A and 1B, an exemplary embodiment of the invention is illustrated. FIG. 1A shows a partial front view of a transaction card carrier assembly 100 in accordance with one embodiment of the invention. Transaction card 110 including text/data information 112a is releasably secured to carrier module 120. As shown in FIG. 1A, transaction card 110 may be affixed to carrier module 120 at top surface 120a, such that the front surface 110a of transaction card 110 is completely visible (i.e., back surface 110b, or a portion thereof, may be secured to carrier module 120). Transaction card 110 may be releasably secured to carrier module 120 in any suitable manner known in the art, such as via adhesive, rubberizing glue strip, or rivet (not shown). In an alternative embodiment (not shown), the transaction card may be integrally formed with the carrier module, and releasable via perforations formed during the manufacturing process, as known in the art (see, e.g., U.S. Pat. No. 5,921,584, the contents of which is herein incorporated by reference in its entirety).

In a preferred embodiment, as shown in FIG. 1A, transaction card 110 preferably is secured to carrier module 120 such that at least a portion of transaction card 110 extends beyond an edge of carrier module 120. As shown, the lower edge 110f of transaction card 110 extends beyond the lower edge 120f of carrier module 120. However, it should be recognized that other configurations are contemplated as within the scope of the present invention. For instance, the side edge of the transaction card could extend beyond a side edge of the carrier module, etc. (not shown). Such configurations, as described in further detail below with reference to FIG. 1B, allow for physical access to various portions of the transaction card while still secured to the carrier module, e.g., magnetic strips by point-of-sales (POS) devices.

With reference to FIG. 1B, a rear view of transaction card carrier assembly 100 is illustrated. As described above, transaction card 110 is releasably secured to the front side of carrier module 120. However, the back side 120b of carrier module 120 is configured such that a transparent window 120c is positioned adjacent to the location of transaction card 110. As such, the back surface 110b of transaction card 110, including data/text information 112b, is visible through transparent window 120c. Carrier module 120 may also include an optional perforated door 120d that may be opened, as known in the art. Such perforated doors may be used to store, e.g., instructional or promotional materials, and may be opened by inserting a user's finder in notch 120d-1 and pulling the perforations open. Carrier module 120 may also include notch 120e for hanging on a display, if desired.

Transparent window 120c may be formed from any suitable material known in the art, such as any transparent plastic, e.g., polyethylene, etc. Carrier module 120 may be formed in any manner known in the art, and from any suitable materials known in the art. By way of example, carrier module 120 may be formed using a sandwich type construction, wherein a top layer and bottom layer (e.g., cardboard materials) sandwich the transparent layer there between. The top and bottom layers may be sized so as to form the transparent window when configured together. Further, if desired, the bottom layer may include the perforated door 120d, such that any enclosed materials are retained between the top layer and the bottom layer.

As mentioned above, the transaction card may be positioned on the carrier module such that at least a portion of the transaction card extends beyond the carrier module. As shown in FIG. 1B, in one embodiment, the lower edge 110f of transaction card 110 may extend beyond the lower edge 120f of carrier module 120. Such a configuration may, e.g., allow for physical access to magnetic strip 110g of transaction card 110. Again, it should be recognized that other configurations are contemplated as within the scope of the present invention. For instance, the side edge of the transaction card could extend beyond a side edge of the carrier module, etc. (not shown).

In an alternative embodiment, not shown, front surface 110a of transaction card 110 may be secured to carrier module 120, such that the front surface of the card, including any data/text 112a thereon, is visible through window 120c. In such an embodiment, the entire back surface 110b is completely visible, including any data/text 112b thereon. In other embodiments, not shown, transaction card 110 does not extend beyond any lateral edge of carrier module 120.

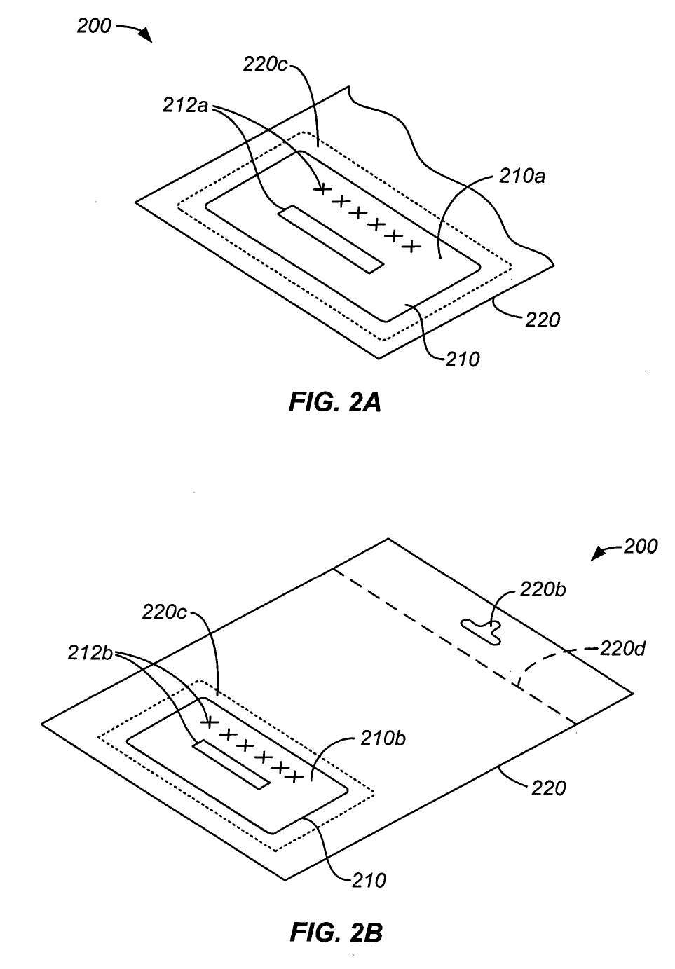

Another embodiment, wherein the transaction card does not extend beyond the carrier module, is illustrated in FIGS. 2A and 2B. With reference to FIG. 2A, a partial view of the front of a transaction card carrier assembly 200 is shown, wherein the front side 210a transaction card 210, including data/text 212a, is visible through window 220c of carrier module 220.

With reference to FIG. 2B, the back 210b of transaction card 210, including data/text 212b, is visible through window 220c of carrier module 220. Carrier module 220 may also include optional perforation or fold 220d and notch 220b for hanging on a display, if desired. Perforation or fold 220d may be used to remove and discard hanging notch 220b, if desired.

Transaction card 210 is located within window 220c and releasably held in place such that data/text 212a is visible. Transaction card 210 may be held in place within window 220c in any suitable manner known in the art, such as via adhesive, rubberizing glue strip, or rivet (not shown). In a preferred embodiment, transaction card 210 may be held in place via a sandwich type construction, wherein a top layer and bottom layer of carrier module 220 are laminated together such that window 220c is created to trap and hold transaction card 210 within window 220c. It should be understood that each layer of the carrier module may itself comprise multiple layers, such that the top and bottom layers each include multiple layers, e.g., a top and bottom cardboard layer with a transparent plastic layer laminated there between. Transaction card 210 may then be removed from window 220c by cutting or puncturing window 220c. Alternatively, window 220c may be formed with perforations to aide in removal of window 220c.

In an alternative embodiment, not shown, transaction card 210 may be releasably secured to the surface of carrier module 220 in any suitable manner known in the art, such as via adhesive, rubberized glue strip, or rivet. In such an embodiment, the front side 210a of transaction card 210 is directly visible and the back side 210b of transaction card 210 is visible through window 220c on the back of carrier module 220. Further, transaction card 210 may be removed from carrier module 220 by pealing the card away from the carrier module, breaking the rivets, etc.

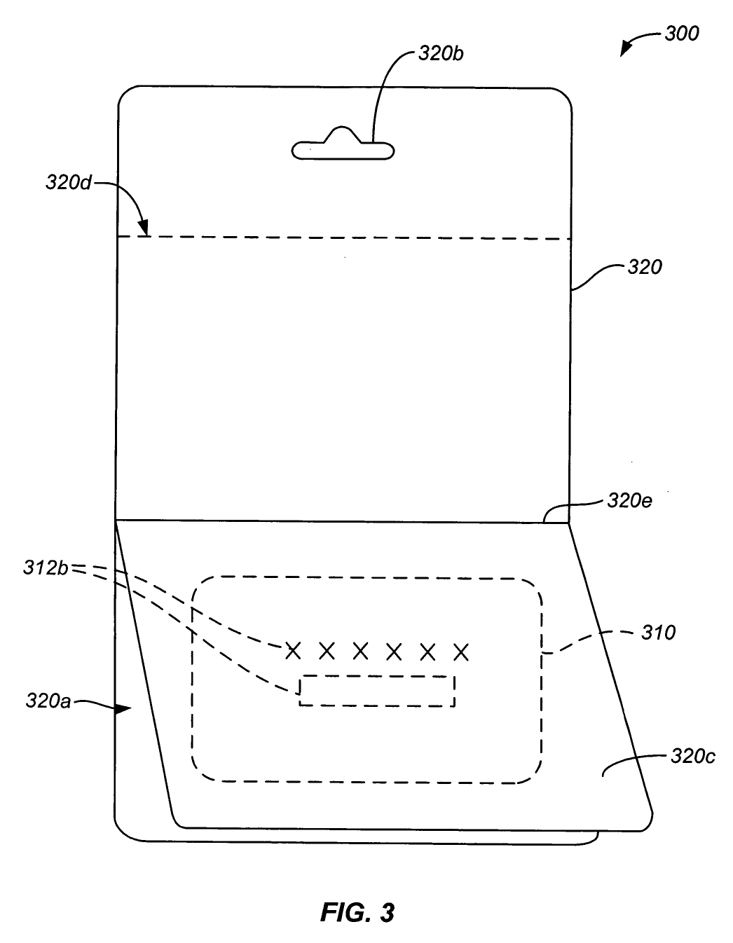

In certain embodiments, it may be desirable to protect the front and/or back face of the transaction card. In other embodiments, it may be desirable to provide additional space for display information. By way of example, with reference to FIG. 3, a transaction card carrier assembly 300 is shown which comprises transaction card 310, including data/text 312b, releasably secured to carrier module 320. Carrier module 320 include flap 320c which folds over surface 320a at line 320e to cover transaction card 310. Again, carrier module may include optional perforation or fold 320d and notch 320b for hanging on a display, if desired. Perforation or fold 320d may be used to remove and discard hanging notch 320b, if desired. Flap 320c may be configured on carrier module 320 on the front and/or the back surface to either provide additional display area and/or provide protection to the underlying transaction card. At the same time, flap 320c allows for access to the transaction card and visibility of data/text information displayed thereon.

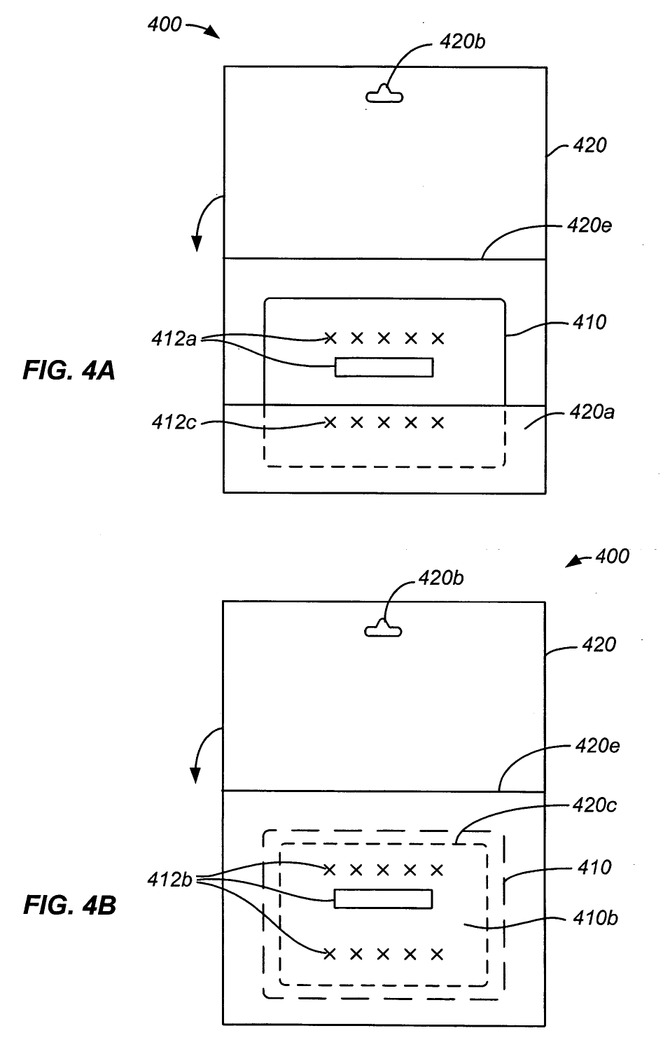

In other embodiments, the transaction card may be enclosed in an envelope style carrier module. For instance, with reference to FIG. 4A, a front view of a transaction card carrier assembly 400 is illustrated comprising transaction card 410, including data/text 412a, releasably secured to carrier module 420 via a retaining pocket 420a. In an alternative embodiment, not shown, transaction card 410 may be secured to carrier module 420 in any suitable manner known in art, such as via adhesive, rubberizing glue strip, or rivet. Any data/text displayed on transaction card 410 which is obstructed by retaining pocket 420a may optionally be printed directly on retaining pocket 420a, e.g., 412c. Alternatively, data/text 412c may be printed anywhere on carrier module 420, so long as it is visible when transaction card 410 is retained in pocket 420a (not shown). Carrier module 420 may further include fold 420e, which may allow for carrier module 420 to fold over on itself to thereby cover transaction card 410 and pocket 420c to create an envelope style carrier envelope. In addition, carrier module 420 may optionally include hanging notch 420b, as well as a perforation or fold for removal of handing notch 420b (not shown), if desired.

With reference to FIG. 4B, a rear view of transaction card carrier assembly 400 is shown. Again, transaction card 410 is secured to carrier module 420 by way of retaining pocket 420a. Carrier module 420 further include a cut-out portion or transparent window 420c, which allows for visual access to the back 410b of transaction card 410, including data/text 412b.

In yet another embodiment, instead of a cut-out or transparent window, any data/text appearing on the back of a transaction card may be reproduced verbatim directly on the back of a carrier module. In this manner, all display information (e.g., transaction card identifier information, terms and conditions of use, instructional information, promotional information, etc.) appearing on a transaction may be visually accessible, even when the transaction card is secured to a carrier.

In other aspects of the invention, various combinations of the embodiments illustrated in FIGS. 1-4 are envisioned. For instance, envelope style carrier modules may be incorporated with transaction cards that extend beyond an edge of the carrier modules. Alternatively, cut-outs may be used in place of transparent windows; rivets may be used in place of adhesives or pockets, etc.

In this way, embodiments in the invention provide novel transaction card carrier assemblies and methods for their production. The description above identifies certain exemplary embodiments for implementing the invention, but those skilled in the art will recognize that many modifications and variations are possible within the scope of the invention. Therefore, the invention is defined only by the claims set forth below.

What is claimed is:

1. A transaction card carrier assembly, said assembly comprising:
a carrier module releasably secured to a transaction card;
wherein said transaction card comprises a front surface and a back surface, each including visual information located thereon; and
wherein said carrier module is configured so as to allow display of substantially all of said visual information located on the front surface and the back surface of said transaction card while said transaction card is secured to said carrier module.

2. The transaction card carrier assembly of claim 1, wherein:
said carrier module comprises a front surface, a back surface, and a transparent window; and
said transaction card is releasably secured to the front surface of said carrier module by way of an adhesive, and is positioned so as to allow for display of substantially all of said visual information located on the back surface of said transaction card through the transparent window of said carrier module.

3. The transaction card carrier assembly of claim 1, wherein:
said carrier module comprises a top layer portion, a bottom layer portion, and a transparent window sandwiched there-between; and
said transaction card is releasably secured to said carrier module by way of placement in said transparent window formed between said top layer portion and said bottom layer portion of said carrier module such that substantially all of said visual information located on the front surface and the back surface of said transaction card is visible through said transparent window.

4. The transaction card carrier assembly of claim 1, wherein:
said carrier module comprises a retaining pocket; and
said transaction card is releasably secured to said carrier module by way of said retaining pocket.

5. The transaction card carrier assembly of claim 4, wherein said carrier module further comprises a cut-out portion or transparent window substantially corresponding in shape and location to said retained transaction card, such that substantially all of the visual information located on the back surface of said transaction card is visible, yet the transaction card is retained within the pocket of said carrier module.

6. The transaction card carrier assembly of claim 1, wherein the back surface of said transaction card is secured directly to the carrier module, and substantially all of the visual information appearing on the back surface of said transaction card is reproduced on the back surface of the carrier module.

7. The transaction card carrier assembly of claim 6, wherein the visual information is reproduced on the back of the carrier module at a location substantially corresponding to the location that the transaction card is secured to the carrier module such that the visual information appears on the carrier module at a location substantially corresponding to the location at which the corresponding visual information appears on the transaction card.

8. The transaction card carrier assembly of claim 6, wherein all visual information is reproduced except any secure account identification information.

9. The transaction card carrier assembly of claim 1, wherein all visual information is visible except any secure account identification information.

10. The transaction card carrier assembly of claim 1, wherein the transaction card is releasably secured to said carrier module such that at least a portion of said transaction card extends beyond the carrier module so as to allow for physical access to said portion of said transaction card.
